(19) United States
(12) Patent Application Publication
(10) Pub. No.: US 2005/0200500 A1
(43) Pub. Date: Sep. 15, 2005

(54) Colorblind vehicle driving aid

(76) Inventor: Thomas W. Wing, Claremont, CA (US)

Correspondence Address: Kit M. Stetina, Esq.;STETINA BRUNDA GARRED & BRUCKER, Suite 250, 75 Enterprise, Aliso Viejo, CA, 92656, US

(21) Appl. No.: 10/799,112

(22) Filed: Mar. 12, 2004

(51) Int. Cl. G08G 1/095

(52) U.S. Cl. 340/907; 340/905; 340/825.19; 348/148

(57) ABSTRACT

A colorblind driving aid installable in a motor vehicle for improving color discrimination of a traffic light. The colorblind driving aid has a detector, a processor and a display. The detector is operative to detect a traffic light within a predetermined distance and preferable at a predetermined angle of sight. The processor is operative to process the traffic light detected by the detector into a form with improved color discrimination. The traffic light processed by the processor is then displayed by the display to the driver of the motor vehicle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates in general to a device and a method to aid a colorblind driver of a motor vehicle, and more particularly, to a device and a method which increases the brightness and contrast of a traffic light to allow the driver who has color deficiency in recognizing the color of the traffic light.

Colorblindness is a condition in which certain colors cannot be distinguished, and is most commonly due to an inherited condition. It has been a general misconception that colorblind people see only black and white or shades of gray. While this sort of condition is possible, it is extremely rare. There are several kinds and degrees of color vision deficiencies, among which red/green colorblindness is by far the most common form. About 99% of the people affected by colorblindness have the problem of distinguishing red and green. Such type of colorblindness does not cause significant disability for most activities in our daily lives. However, driving a motor vehicle for this type of colorblindness can be very frustrating and hazardous.

In most states of the United States, vertical traffic lights with red on top, yellow in the center and green on the bottom are used. Therefore, many red/green colorblind drivers recognize the color of the light according to its vertical position. However, in certain States such as Texas, the colors of the traffic light are arranged horizontally thereby causing temporary problems for the colorblind drivers. Further, in the situation where there is only one light flashing with red and/or a yellow color, it causes the red or yellow colorblind people great difficulty to determine or recognize the correct color of light.

Thus there is a substantial need in the art to develop a colorblind driving aid and a method to improve color discrimination of the traffic light for colorblind people, particular those who suffer minor deficiency in red and green.

### BRIEF SUMMARY OF THE INVENTION

The present invention provides a colorblind driving aid installed in a vehicle for improving color discrimination of a traffic light. The colorblind driving aid includes a detector, a processor and a display. The detector is operative to detect a traffic light within a predetermined distance and a predetermined angle. The processor is operative to process the traffic light detected by the detector into a form with improved color discrimination. The traffic light processed by the processor is then displayed by the display. Preferably but optionally, the detector and the processor are integrated to one camera. The display may also be integrated to the same camera. The detector is preferably installed in a position inside the vehicle without obstructing the view of the driver. It also allows the detector to detect the traffic light through a windshield of the vehicle. The predetermined distance is a distance between the traffic light and the vehicle within which the traffic light is observable to the driver. When the detector is within the predetermined distance of the traffic light, the detector is operative to detect the traffic light in an area from about the 11 o'clock position to 4 o'clock position with respect to the driver.

In one embodiment of the present invention, the colorblind driving aid further comprises at least one filter to filter wavelengths of light beyond the wavelength ranges of red, yellow and green. The display may include a liquid crystal display, a light-emitting diode display, or a miniature of the traffic light on which the green light, yellow light and red lights are vertically arranged or arranged in accordance with the traffic light. To further enhance color discrimination of the traffic light, the colorblind driving aid may also comprise a memory of pre-recording sounds indicating colors of the traffic light and an audio device operative to output such sound. The audio device may include a speaker built-in the camera, an external speaker installed in the vehicle and in electric communication with the processor, or a built-in speaker of the vehicle. The memory may also pre-record texts indicating colors of the traffic light. By electrically connecting the memory with the display, the texts can be displayed by the display;

The present invention further provides a method of improving color discrimination of a traffic light for a colorblind driver. A traffic light positioned within a predetermined distance and a predetermined viewing angle is detected and processed into a form with improved color discrimination for the driver. The processed traffic light is then displayed to the driver. The step of processing the traffic light may include increasing brightness and/or contrast of the traffic light. The method may further comprise a step of filtering unwanted wavelengths of the detected light. Preferably but optionally, a step of generating a text indicating the color of the traffic light is performed either simultaneously or by a short instant before or after the step of displaying the light. A step of generating a sound indicating the color of the traffic light may also be performed to further assist the driver to discriminate the color of the traffic light.

### BRIEF DESCRIPTION OF THE DRAWINGS

These as well as other features of the present invention will become more apparent upon reference to the drawings therein:

FIG. 1 is a schematic drawing of a colorblind driving aid applied in a vehicle;

FIG. 2 illustrates a block diagram of the colorblind driving aid;

FIG. 3 shows a exemplary pattern of the display of the colorblind driving aid; and

FIG. 4 is a flow chart showing the method of aid for colorblind driver.

### DETAILED DESCRIPTION OF THE INVENTION

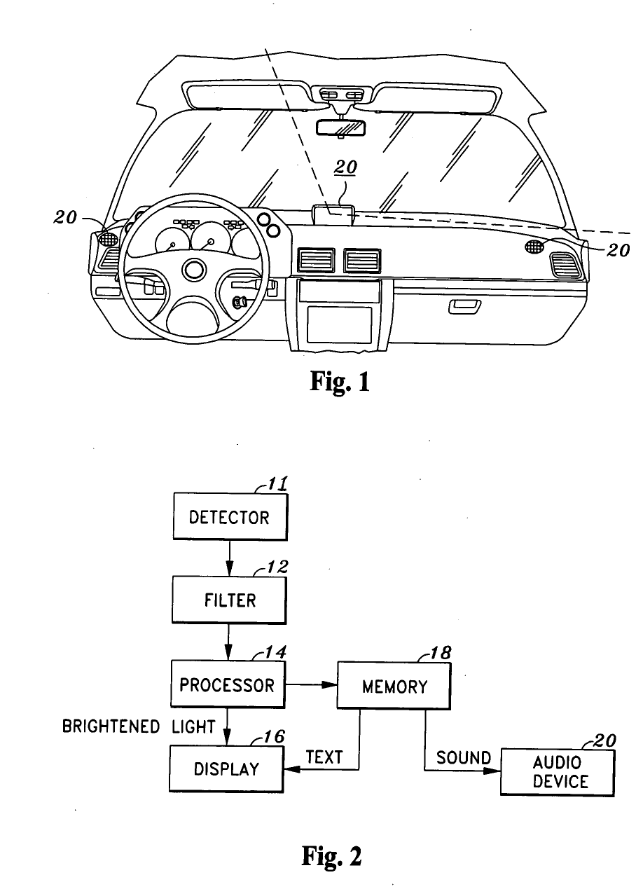

Referring now to the drawings wherein the showings are for purpose of illustrating preferred embodiments of the present invention only, and not for purposes of limiting the sane. FIG. 1 schematically illustrates a colorblind driving aid 10 applied to a motor vehicle, and FIG. 2 is a block diagram showing the components of the colorblind driving aid 10. As shown in FIG. 2, the colorblind driving aid 10 includes a detector 11 preferably located in an area that does not obstruct the view of the driver. The detector 11 is effective to scan an area in front of the vehicle from about an 11 o'clock position to about a 4 o'clock position with respect to the driver within a predetermine distance. The effective distance of the detector is preferably the distance from which the driver is typically able to visually observe the presence of the traffic light. For example, the effective distance is about 50-100 yards ahead of the vehicle. When a traffic light exists in the effective area, the detector 11 captures and outputs the light from the traffic light to a filter 12 operative to filter unwanted wavelengths of light. In this embodiment, as the detector 11 is used to detect the traffic light which is either red, yellow or green, the light having wavelengths outside of the red, yellow and green wavelength ranges is filtered and eliminated by the filter 12. That is, only the red, yellow or green light captured by the detector 11 will transmit through the filter 12. The light transmitting through the filter 12 is then input to a processor 14. The light is then processed by the processor 14 into a form of which the color is more easily recognized by the colorblind driver. For example, the brightness or contrast of the light is increased to allow the drivers to better distinguish the color thereof. The processed light is then output to a display 16 and displayed thereby.

Preferably but optionally, the colorblind aid may further comprise a memory 18 in which a plurality of texts and sounds is pre-stored. For example, the texts and sounds of red, yellow, blue, and stop can be pre-recorded in the memory 16. When the light captured by the detector 11 and filtered by the filter 12 is input to the processor 14, the processor 14 is then operative to generate a signal to retrieve the text and/or sound of a memory 16 in correspondence with the color or information of the light. For example, when a red light is captured by the detector 11 and input to the processor 14, a signal operative to retrieve the text and/or sound of “red” is generated by the processor 14. The signal is then sent to the memory 16, such that the text and/or sound of “red” is output to a device operative to output the text and/or sound of “red”. In this embodiment, the memory 16 is in electric communication with an audio device 20 and the display 16 for outputting the sound and text retrieved thereby. The audio device 20 typically includes a speaker. Preferably but optionally, the memory 16 can be electrically connected to one or more of the existing built-in audio sound system speaker of the vehicle. The display for showing the text may be different from that for showing the brightened light according to specific requirement.

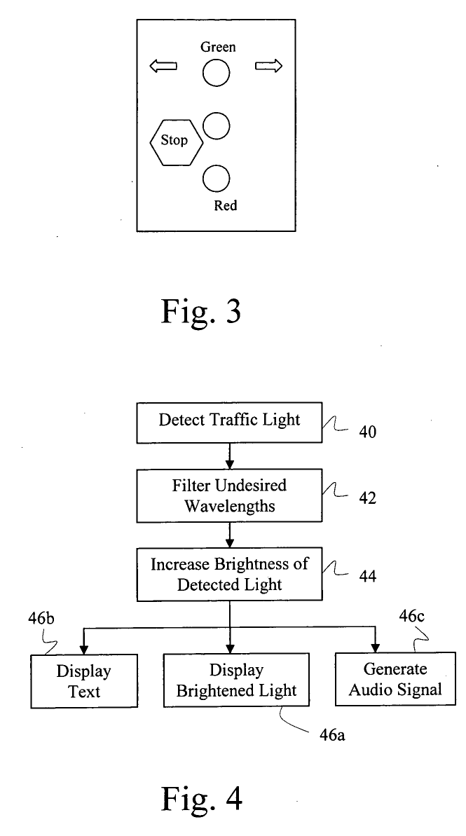

In the embodiment as shown in FIG. 1, the detector 11, the filter 12, the processor 14, and the display 16 are integrated into one camera 10, while the built-in speaker of the vehicle is used as the audio device 20. However, it is appreciated that the detector 11 and the display 16 can be installed at the different positions of the vehicle without exceeding the scope and spirit of the present invention. The display 16 preferably comprises a flat panel display such as a light-emitting diode display or a liquid-crystal display (LCD). Alternatively, the display 16 may be in the form of a miniature traffic light as shown in FIG. 3. The miniature traffic light includes a left-turn arrow, a right-turn arrow, a red light on the top, a yellow light in the center and the green on the bottom. As mentioned above, the light captured by the detector 11 is intensified or brightened by the processor 14, so that the light displayed by the miniature of the traffic light is easier for the colorblind driver to distinguish. In addition to the brightness increase, to further enhance color discrimination of the light, texts of the color may also be printed on the display 16 as shown in FIG. 3, or the light can be brightened with a flashing effect. Further, in addition to the colors and direction representation, other light such as a stationary stop light or a stop light disposed on a school bus can also be detected by the detector 11 and displayed by the display 16.

FIG. 4 illustrates a method of improving color discrimination of traffic light for a colorblind driver, particularly for a colorblind driver having red or green color deficiency. As shown in step 40, when the vehicle driven by the colorblind driver is approaching an intersection with a traffic light, the traffic light is detected. To avoid the interference from the light having undesired wavelengths, the detected light is filtered in step 42. The resultant light from the filtering step is then processed to a better form that provides better color discrimination for the driver in step 44. Preferably, the brightness of the light is increased. The processed light is then output and displayed to the driver in step 46a. In addition to the visual presentation of the processed light, text indicating the color or information of the captured light can also be displayed in step 46b. In addition to the display of the light and text, a sound indicating the color information can also be output in step 46c. It will be appreciated that steps 46a, 46b and 46c can be performed simultaneously or intermittently by a small lag of time.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A colorblind driving aid installed in a vehicle for improving color discrimination of a traffic light, comprising:
a detector, operative to detect a traffic light within a predetermined distance at a predetermined angle;
a processor, operative to process the traffic light detected by the detector into a form with improved color discrimination; and
a display, operative to reproduce the traffic light with improved color discrimination.

2. The colorblind driving aid of claim 1, wherein the detector and the processor are integrated to a camera.

3. The colorblind driving aid of claim 1, wherein the detector, the processor and the display are integrated to a camera.

4. The colorblind driving aid of claim 1, wherein the detector is disposed in a position inside a vehicle allowing the detector to detect the traffic light through a windshield of the vehicle.

5. The colorblind driving aid of claim 1, wherein the predetermined distance is a distance between the traffic light and the vehicle within which the traffic light is visible to the driver.

6. The colorblind driving aid of claim 1, wherein when the detector is within the predetermined distance of the traffic light, detector is operative to detect the traffic light in an area from 11 o'clock position to 4 o'clock position with respect to the driver.

7. The colorblind driving aid of claim 1, further comprising at least one filter to filter wavelengths of light beyond the wavelength ranges of red, yellow and green.

8. The colorblind driving aid of claim 1, wherein the display includes a liquid crystal display.

9. The colorblind driving aid of claim 1, wherein the display includes a light-emitting diode display.

10. The colorblind driving aid of claim 1, wherein the display includes a miniature of the traffic light.

11. The colorblind driving aid of claim 1, further comprising:
a memory pre-storing sounds indicating colors of the traffic light; and
an audio device, operative to output the sound.

12. The colorblind driving aid of claim 11, wherein the memory pre-stores texts indicating colors of the traffic light.

13. The colorblind driving aid of claim 12, wherein the memory is in electric communication with the display.

14. A method of improving color discrimination of a traffic light for a colorblind driver, comprising:
detecting a traffic light in front of a driver within a predetermined distance and a predetermined viewing angle;
processing the traffic light into a form with improved color discrimination for the driver; and
displaying the processed traffic light to the driver.

15. The method of claim 14, wherein the step of processing the traffic light includes increasing brightness of the traffic light.

16. The method of claim 14, further comprising a step of filtering unwanted wavelengths of the detected light.

17. The method of claim 14, further comprising a step of generating a text indicating the color of the traffic light.

18. The method of claim 14, further comprising a step of generating a sound indicating the color of the traffic light.
